(19) United States
(12) Patent Application Publication
(10) Pub. No.: US 2025/0008989 A1
(43) Pub. Date: Jan. 9, 2025

(54) Apparatus and method for preserving beverages with system monitoring

(71) Applicant: LANXESS Deutschland GmbH, Köln (DE)

(72) Inventors: Gerhard SARTORIUS, Giessen (DE); Axel KUBATZ, Staufenberg (DE); Jonas BURGHOLZ, Köln (DE); Erasmus VOGL, Bergisch Gladbach (DE)

(21) Appl. No.: 18/710,891

(22) PCT Filed: Nov. 14, 2022
(86) PCT No.: PCT/EP2022/081785

§ 371 Date: May 16, 2024

(30) Foreign Application Priority Data
Nov. 16, 2021 (EP) 21208425.5

(51) Int. Cl. A23L 3/3517; A23L 2/44; A23L 3/00

(52) U.S. Cl. CPC A23L 3/3517; A23L 2/44; A23L 3/003

(57) ABSTRACT

Disclosed is an apparatus for preserving beverages, having a measuring device for determining a flow rate of a liquid flowing through a beverage line, and having a pump device configured for conveying a preserving agent, in particular dialkyl dicarbonates, into the beverage line, and having at least one further measuring device which determines at least one further characteristic measured value, wherein the apparatus has a control device for controlling the pump device, the pump device can be controlled as a function of a flow rate determined by the measuring device and as a function of the further measured value,
and a storage device which enables at least the further characteristic measured value to be stored repeatedly.

The invention relates to an apparatus and a method for monitoring a plant for the preservation of beverages and to the use of the apparatus for this purpose.

Preservatives such as dialkyl dicarbonates, sulphur dioxide, natamycin, benzoates or sorbates are used in the beverage industry for the cold sterilisation of non-alcoholic carbonated or still fruit juice drinks, fruit juices, wines, non-alcoholic wines, ciders, iced teas and other beverages. Dialkyl dicarbonates, such as dimethyl dicarbonate or diethyl dicarbonate in particular, are a special cold sterilising agent with a number of advantages. The outstanding advantage here is the fact that, in contrast to hot filling, taste and colour are not affected. Compared to persistent preservatives, such as sodium benzoate or benzoic acid or potassium sorbate or sorbic acid, the advantage lies in the absence of any flavour impairment and the disappearance of the effect. Due to the decomposition of dialkyl dicarbonates into harmless components, no preservative is consumed by the actual consumer.

Compared to cold aseptic filling, the significantly lower investment costs in plant technology are a well-known advantage of using dialkyl dicarbonates.

In the state of the art, built-in diaphragm dosing pumps are used to add dialkyl dicarbonates, for example in the beverage line, which allow dialkyl dicarbonates to be introduced into the ongoing beverage flow. Otherwise, uniform and reliable distribution in the beverage cannot be guaranteed. One advantage of diaphragm pumps is that their pump chamber is completely sealed.

However, other types of pumps can also be used. The apparatus with diaphragm pumps usually consists of a magnetically or electrically driven diaphragm pump, storage vessels, an apparatus attached to the beverage line for atomising the dialkyl dicarbonate, a flow meter attached to the beverage line and an electronic control unit. Dosing pumps of this type are usually permanently installed in the beverage line.

The dosing pumps are advantageously suitable for several different performance parameters, in particular for small and very small quantities. In addition, these dosing pumps should have a high dosing accuracy, a high atomisation pressure during the entire atomisation time and a wide control range.

The function of these devices is based on the on-line measurement of the beverage flow rate in the beverage pipe and the quantity of dialkyl dicarbonate to be dosed calculated in parallel. Dialkyl dicarbonates are thus proportionally dosed in each case into the beverage pipe in the required quantity. Examples of these pumps are the VelcorinDT devices from Lanxess.

One disadvantage of the described dosage into the beverage flowing past is that the devices can generally fail, for example if minor or major mechanical or electronic defects occur. If this failure occurs during ongoing production, there is a risk that a large quantity of bottled beverages will not be produced as originally planned and, in extreme cases, will have to be categorised as unsaleable. In extreme cases, this defect in the dosing device is only recognised retrospectively and the goods produced cannot be used.

Unfortunately, continuous online monitoring via a control station, for example from the manufacturer, is often impractical.

The present invention is therefore based on the object of enabling improved monitoring of the apparatus described here. According to the invention, this object is achieved by the subject matters of the independent patent claims. Advantageous embodiments and further developments are the subject of the subclaims.

An apparatus for preserving beverages according to the invention has a measuring device which is suitable and intended for determining a flow rate of a liquid flowing through a beverage line, and in particular of a beverage, and preferably for outputting a measured value which is characteristic of this flow rate. Furthermore, the apparatus has a pump device which conveys a preservative, in particular a liquid preservative and in particular dialkyl dicarbonates, into the beverage line and at least one further measuring device which determines at least one further characteristic measured value for the operation of the apparatus, wherein the apparatus has a control device for controlling the pump device, which controls the pump device as a function of a flow rate determined by the measuring device and as a function of the further measured value. This corresponds, for example, to an electronic readjustment of the dosing quantity.

According to the invention, the apparatus has a storage device which enables at least one further characteristic measured value to be stored and, in particular, repeatedly stored. In addition or alternatively, the apparatus has an evaluation device which evaluates the data recorded by the measuring devices. This evaluation can be carried out using a model, in particular a simulation model and in particular using a simulation-dosage model.

In a preferred embodiment, the storage device allows the measured value to be stored with a time assignment. Preferably, the storage also allows a measured value characteristic of the flow rate and/or a measured value recorded by means of the above-mentioned measuring device to be stored.

In a preferred embodiment, the apparatus has at least one receiving container for at least temporarily holding the preservative. Preferably, this receiving container is arranged upstream or before the pump device in a flow direction of the preservative. Particularly preferably, the pump device can remove the preservative from this receiving container.

Preferably, the apparatus has a venting device for venting the pump device. This venting device preferably has a measuring device or sensor device which determines at least one measured value which is characteristic of a venting state of the pump device.

In a further advantageous embodiment, the apparatus has a further receiving device for receiving the preservative. It is possible that the preservative is first conveyed from one of the two receiving devices into the second receiving device. The second receiving device(s) is particularly preferably a receiving container and, in particular, a buffer container.

In a further advantageous embodiment, the apparatus has a comparison device which is suitable and intended for comparing the characteristic measured value with a reference value. For example, a difference between the reference value and the measured value can be determined. A quotient can also be formed between the characteristic measured value and the reference value. This reference value or target value can be a predefined target value and/or a measured value that is also stored in the storage device.

It is also possible to check whether a deviation between the measured value and the target value and/or reference value is within predetermined limits. If this is not the case, an alarm can be issued.

In a further preferred embodiment, the apparatus has an alarm output device which is suitable and intended to output an alarm when a fault condition occurs. Preferably, the above-mentioned storage device is suitable and intended for storing data characteristic of this alarm. For example, a time of the alarm output and the said measured value and, if necessary, further measured values can be stored.

The storage device can be an internal storage device, e.g. arranged on or in the pump device or its control, but it can also be a cloud or an internet storage.

In a particularly preferred embodiment, the apparatus has at least two further measuring devices, preferably at least three further measuring devices and particularly preferably at least four further measuring devices, each of which determines at least one measured value characteristic of the operation of the apparatus. These measuring devices are particularly preferably arranged at different positions of the apparatus, for example in a suction line, by means of which the preservative is conveyed from a receiving container to the pump device, in a pressure line, which leads from the pump device to the beverage line and the like.

In a preferred embodiment, the apparatus has an injection device which is suitable and intended for injecting a preservative conveyed by the pump device into the beverage line.

It is particularly preferable for the apparatus to have a timing measurement device and/or a timer. In this way, it is possible to store recorded measured values together with a time value. Particularly preferably, the apparatus has a timer that controls and/or triggers the storage of the measured values.

In a further advantageous embodiment, at least one measured value is selected from a group of measured values which is characteristic for a pressure of the preservative, for a temperature of the preservative, for an external temperature, for a flow rate of the preservative, for a filling level of the preservative (within a receiving container), for the presence of a gas in the pump device, for a pressure under which the preservative is conveyed into the beverage line, for a temperature of the beverage, a temperature of an injection device by which the preservative is injected into the beverage line and the like.

Preferably, the injection device, which injects the preservative into the beverage, is arranged in a curved area of the beverage line or injects the preservative in a curved area of the beverage line. In this way, the turbulences of the beverage occurring in this curved area can be utilised for injecting the preservative.

The invention is based on the idea that corresponding values are recorded with a plurality of measuring devices and these values are preferably stored continuously and/or cyclically. In this case, online monitoring of the apparatus can preferably be dispensed with, but data can be derived from the stored values at the same time, if necessary also later.

Preferably, a measuring device is also provided which detects a position of the pump device and/or a value characteristic of the operation of the pump device, for example a position of the diaphragms or a valve position of valves of the pump device. This detection is particularly preferably time-dependent. This can take place, for example, via a position sensor, but other data can also be analysed, such as a torque or a power of a drive device of the pump device, or corresponding currents and/or voltages.

Preferably, the pump device is therefore suitable and intended for recording essential and in particular all important machine and/or consumption data and preferably storing them and particularly preferably storing them directly. In addition, alarms or error states are preferably also recorded and, in particular, recorded so that they can be transmitted. This data can be, for example, a consumption of the preservative per unit of time, a pressure in the pressure line in which the preservative is conveyed from the pump device to the beverage line, or the like.

For example, it is possible that a position of a mechanical element of the pump device, a suction-side pressure of the preservative, a pressure-side pressure of the preservative, a temperature of the preservative, a filling level of a buffer vessel in which the preservative is located, a flow rate of the beverage and possibly further data are stored at a certain point in time. This data can, for example, be recorded as n-tuples of related data.

In a preferred embodiment, the apparatus has an interface, and in particular a data communication interface, which enables data communication with a further control device and/or with a further storage device.

For example, a touch panel function with a storage size that allows machine data to be stored at intervals of less than 20 seconds, preferably less than 10 seconds, preferably less than 5 seconds and particularly preferably less than 2 seconds, can be provided.

Preferably, an interface, for example a USB interface (particularly preferably outside an appliance cabinet of the apparatus) is provided, which also allows (manual) access to the stored data for persons who are not electronically instructed.

Preferably, the apparatus has a control device which enables the apparatus to be controlled by a control centre of the operator.

In a further preferred embodiment, the apparatus, and in particular the pump device, has a storage device which is suitable and intended to record all important machine and consumption data and preferably to store these in a transmittable manner. Furthermore, the storage device is preferably also suitable and intended to record alarm states and preferably all alarm states and preferably to record them in a transmittable manner.

In a further preferred embodiment, the pump device is a dosing pump. The pump device is particularly preferably a diaphragm pump, wherein the use of a piston pump is also possible.

For example, an IoT (Internet of Things) gateway can be provided, which is preferably integrated into the pump device. This can be designed as an electronic controller and/or circuit card, for example. It is possible for this IoT to use a SIM card or other telecommunications connections to allow the pump device data recorded by the storage device to be transmitted to a further storage device or a higher-level process controller at predetermined intervals, for example once a day.

This transmission can take place via telephone connections or extra available IoT bandwidths, for example. The further storage device can also be a cloud, for example, or a central storage facility of the machine manufacturer. This enables the machine manufacturer to monitor apparatus located at other sites and, if necessary, issue statements that are required for operation. For example, by analysing this data, a customer can be informed that certain components need to be replaced, such as valves or the diaphragms of a diaphragm pump or similar.

It is possible that the transmission of this data is integrated into the software of the pump device and takes place automatically. In addition, it would also be possible for the relevant data to be requested from a cloud storage by a query device or to be triggered there itself.

Preferably, the above-mentioned storage device is suitable and intended for storing a plurality of different values characteristic of the apparatus and/or its operation and/or the preservative. Preferably, this storage takes place together with a time stamp or with a time.

Preferably, the apparatus has a data reduction or data compression device that reduces the amount of data stored. For example, it would be possible for measured values that do not change over a specified period of time, such as temperatures, to store only a temperature and a relevant period of time over which this temperature was constant.

Unforeseen machine conditions can be recognised from the recorded data, in particular after transmission to the further storage device, such as a cloud, and in this way, for example, a proactive service action can be initiated. For example, an alarm table can be analysed (preferably continuously or cyclically). This can be done, for example, with the help of defined alarm accumulation threshold values.

For example, an alarm is always triggered if the dosage of dimethyl dicarbonate is too low (under-dosage alarm). This alarm can occur, for example, if incorrectly stored dimethyl dicarbonate has been used, which is beginning to decompose, resulting in decomposition in the dosing pump or pump device in carbon dioxide gas and the pump device is then often only incompletely vented and the dosage is reduced in this state. The insufficient dosage can be detected, for example, by means of a flow measuring device, but also with suction-side pressure measuring devices.

If an accumulation of under-dosage alarms is detected during the automatic or manual evaluation of the data on a storage device (e.g. a cloud storage), the beverage bottling plant (user) can be contacted proactively to draw attention to this faulty situation. As a countermeasure, the dimethyldicarbonate can be replaced, for example.

Deviations can also be used from the recorded machine data, in particular the electrically monitored dosage, to deduce incorrect behaviour of the machine.

The electronic readjustment can also be used to deduce a change in the dosing pump from the course, in particular from the changes, for example to wear of individual pump parts such as valves or the like.

In a further advantageous embodiment, the apparatus has an operating device which enables an user input, wherein this operating device preferably has a display device for displaying data and/or measured values, wherein these measured values are preferably characteristic of the apparatus and/or the operation of the apparatus.

For example, a touch panel function can be provided, which preferably has a storage device or storage size that enables machine or operating data to be stored at intervals. These intervals are particularly preferably less than 20 seconds, preferably less than 10 seconds, preferably less than 5 seconds and preferably less than 2 seconds.

However, it would also be possible to record data or a small amount of data at even shorter time intervals. For example, suction-side and pressure-side pressure values of the pumping device could be recorded over a short period of time and for this at short intervals, for example to monitor one or several pumping cycles of the pumping device.

For example, it is possible to check how controlling the pump affects the corresponding pressure values. This data can be transmitted repeatedly, for example once a day or once a week. In this way, it is possible to determine how the delivery behaviour of the pump changes over time depending on its control. In this way, for example, the user can be informed whether and, if so, which components of the pump need to be replaced in the near future.

In a further advantageous embodiment, the apparatus has a further communication interface which enables data to be transmitted to an external storage device or an external apparatus in relation to the apparatus. This interface can be an automated interface that transmits a plurality of data to the higher-level storage device once a day, for example.

In a particularly preferred embodiment, the storage device is suitable and intended for storing data characteristic of an error state of the apparatus. For example, a time of an occurring fault, measured values of this fault and the like can be recorded and/or stored.

If, for example, a certain measured value, such as a measured pressure value on the pressure side, is outside a specified tolerance window, this can be recorded and the corresponding time can also be recorded at the same time. This makes it possible to analyse faults at a later date and forecasts can be made that indicate a specific cause of the fault.

In a preferred embodiment, a processor device is provided which outputs at least one value characteristic of a forecast on the basis of previously recorded and/or stored values. For example, it can be determined from a plurality of recorded data that a certain pressure value of the pump device is continuously changing. This can be an indication of an imminent failure of a certain machine part and the user can be informed of this.

In this way, it is possible to recognise a future failure of an apparatus part (based on the data or measured values). Preferably, artificial intelligence (AI) can be used for this purpose.

The above-mentioned evaluation device is in particular suitable and intended for retrieving a predetermined plurality of measured values (preferably in particular measured values recorded by the measuring devices) stored in particular on a non-volatile storage device and for processing the retrieved plurality of spatially resolved measured values or data derived therefrom using a machine learning simulation-dosage model, in particular a trainable simulation-dosage model, which comprises a set of parameters, in particular trainable parameters, which are set to values that have been learnt as a result of a training process.

In a preferred embodiment, the storage device allows repeated storage of data with time intervals of less than 5 seconds, preferably less than 2 seconds, preferably less than 1 second, preferably less than 500 ms, preferably less than 200 ms and particularly preferably less than 100 ms. In this way, rapidly changing states can also be recorded, such as those that occur during a pump cycle.

In a preferred embodiment, the apparatus comprises a transmission device which is suitable and intended for transmitting the data recorded by the storage device to a further storage device.

The present invention is further directed to a method for monitoring an apparatus for preserving beverages. A measuring device records a flow rate of a liquid flowing through a beverage line and a pump device delivers preservative, in particular dialkyl carbonates, into the beverage line and at least one further measuring device determines a further characteristic measured value for the operation of the apparatus, wherein the apparatus has a control device for controlling the pump device and/or a control device controls the pump device and the pump device is controlled as a function of a flow rate determined by the measuring device and as a function of the further measured value.

According to the invention, the apparatus has a storage device which stores the further characteristic measured value, in particular repeatedly. Preferably, this is a storage device which stores the measured value over a longer period of time (in contrast to, for example, a volatile storage), in particular a period of time which is greater than 1 second, preferably greater than seconds, preferably greater than 1 minute and preferably greater than 10 minutes and particularly preferably greater than 1 hour.

In a further method according to the invention, an evaluation device evaluates the above-mentioned measured value(s), in particular using artificial intelligence (AI). This configuration can be carried out as an alternative or cumulatively to the above-mentioned storage of data. Preferably, the evaluation is carried out using a model and in particular a simulation model and in particular a simulation-dosage model. This model can take into account dependencies between the individual measured values and a specific controlled variable, such as a pump performance.

It is particularly preferable to store the measured values with a time assignment, i.e. in particular together with a time value characteristic of the time of their occurrence.

Preferably, a plurality of measuring devices (and/or sensor devices) is used to record a plurality of measured values characteristic of the operation and the storage device preferably stores these measured values repeatedly and/or cyclically. For example, several measured values or a set of measured values can be recorded at many different points in time, for example more than 10, preferably more than 20, preferably more than 50 and preferably more than 100 and preferably more than 500 different points in time.

Preferably, an n-tuple of measured values is stored in this way. It is particularly preferable to store the data at intervals of less than 1 minute, preferably less than 30 seconds, preferably less than 20 seconds, preferably less than 10 seconds, preferably less than 5 seconds and preferably less than 2 seconds. In this way, very precise observation of the apparatus is possible, both over longer periods of time and over shorter periods of time and with greater accuracy.

Preferably, the interval at which measured values are recorded and stored can be changed. It is possible for the user to specify corresponding time intervals. However, it would also be possible for the apparatus to change the time intervals. For example, it would be possible for a time interval to be shortened if one or several measuring devices output atypical measured values.

Preferably, a plurality of stored measured values is transmitted to a storage device. For example, it is possible that a number of n data sets, for example 1000, 2000 or 3000 data sets, were recorded on a certain day, wherein the above-mentioned measured values were recorded at different times.

In a further preferred method, the apparatus is controlled and, in particular, readjusted on the basis of the measured values recorded. It is therefore possible for the control and/or regulation to be carried out with reference to and/or taking into account the measured values recorded. In this way, the measuring device or devices can be integrated into a control loop for controlling the pump device.

This complete data set can be transferred to a further storage device such as a cloud, which can be done once a day, for example. This variety of data can in turn be used to derive operating data for the machine or, if necessary, to make forecasts. For example, this plurality of data can be used to determine that a certain pressure value has continuously dropped. Countermeasures can be derived from this, such as replacing the preservative. It is preferably possible for this plurality of data records to be transmitted wirelessly.

In a preferred method, characteristic data for error states of the apparatus are recorded and/or stored. For example, alarm states can occur if certain measuring devices fail. In addition, alarm states can occur or be recorded if it is determined that too little preservative is being added to the beverage. It would therefore be possible for corresponding alarm states to be stored at a certain point in time.

By also observing these error states, it is possible to determine, for example, that the frequency of a certain error state changes over time. Conclusions can also be drawn from this, which are characteristic of the operation of the apparatus.

Particularly preferable, values are output directly to a user via a display device. This can be, for example, measured pressure values or similar or the output of alarms when certain error states occur.

Surprisingly, it was found in the context of the invention that it is still possible to support users with practically all the advantages of genuine online monitoring, using much simpler components and controls.

The electronic readjustment can also be used to derive a change in the pump device or dosing pump from the course and, in particular, from the changes.

A further advantage of the invention is that the regular transmission function of machine and consumption data from the dosing pump of the beverage filling operation provides an additional safety function in the event of any loss of consumption data. For example, the software or hardware of the dosing pump may be damaged due to an electronic defect or, for example, due to an overvoltage event in the production system, and it may no longer be possible to query the data locally on the dosing pump, even via the USB output.

Thanks to the continuous additional data storage, which is sent to the cloud storage via the IoT gateway, it is still possible to record a history up to the time the damage occurred and retrieve this data if required.

Furthermore, it was surprisingly found that the correlation of the external temperature with the dosage correction factor allows a reliable diagnostic statement to be made about the condition of the dosing pump. It was found that for each dosing pump there is a fixed correlation of the dosage correction at a given temperature. If the dosage correction changes significantly at the respective temperature compared to the previously transmitted values, there is an increased probability that mechanical damage is imminent.

Furthermore, errors in operation can be recognised, for example if bottle changes are not carried out on time and a standstill alarm is triggered. This data can then be used to derive and offer proactive training for operators, for example.

Furthermore, new parameters can be derived for monitoring correct production processes. For example, the additional monitoring of the beverage temperature and density makes it possible to check the Brix setting in addition to, in parallel with or instead of the analytical evaluation in the laboratory and to store it as a necessary criterion for release by means of a setting in the software.

Furthermore, the effectiveness of the CIP (cleaning in place) process can be monitored by measuring the temperature and its time curve in the flow meter. A temperature and time query can be used to classify whether the cleaning and disinfection process will be sufficient. Depending on the level of safety achieved, the preset quantity of dialkyl dicarbonate can then be automatically increased or reduced. Alternatively, the quantity of dialkyl dicarbonate can be kept constant, but the operator can be alerted to the hygiene situation by a query on the dosing pump, in particular with the option of manual readjustment.

Dimethyldicarbonate is particularly preferably used as dialkyldicarbonate, even more preferably dimethyldicarbonate with a purity >99.8% is used as dialkyldicarbonate. In a further embodiment of the invention, dimethyldicarbonate is used which has been stabilised by suitable processes.

Such processes, such as the use of a phosphorus compound from the series of phosphorus oxides, phosphorus-oxygen acids and derivatives thereof, are known, for example, from EP 2 013 160 B1. EP 2 016 041 B1 describes the use of at least one protonic acid from the series of inorganic acids and organic carboxylic acids and their derivatives, wherein the organic carboxylic acids are saturated and mono- or polyunsaturated aliphatic monocarboxylic acids and saturated and mono- or polyunsaturated aliphatic di- and polycarboxylic acids and their derivatives are hydroxamic acids, hydroxycarboxylic acids, aldehyde and keto acids, for stabilising dialkyl dicarbonates against chemical and thermal degradation reactions, wherein the protonic acid or mixtures thereof is present in an amount of 0.01 to 100,000 ppm relative to dialkyl dicarbonates or mixtures thereof.

In a further embodiment of the invention, dimethyldicarbonate is used in a mixture with phosphorus compounds, such as preferably phosphates, even more preferably with trimethylphoshate or phosphoric acid. Preferably, the phosphorus compound is used in an amount between 0.01 ppm and 1000 ppm relative to the total amount of the mixture of dimethyldicarbonate and phosphorus compounds.

In a further preferred method, at least one statistical forecast value (such as a preset dosage size) is determined by processing and/or analysing the plurality of measured values or data derived therefrom and, if necessary, further additional process steps (in particular computer-implemented process steps). In particular, the dosage size relates to the preservative to be dosed into the beverage line.

Preferably a plurality of measured values is used, in particular from different measuring devices. Preferably more than two, preferably more than three and particularly preferably more than four measuring devices are provided, the measured values of which are analysed. These are preferably measured values that are characteristic of different state variables, such as flow rates, pressures, temperatures, pump performances, etc.

Preferably, the (recorded and/or stored) measured values are time-resolved measured values, for example measured values that were recorded over a specified period of time. Preferably, a plurality of different measured values is recorded and/or stored over a predetermined period of time.

The evaluation device processes the retrieved (predetermined) plurality of measured values or data derived therefrom using a, in particular trainable, simulation-dosage model of machine learning, which comprises a set of, in particular trainable, parameters that are set to values that were learnt as a result of a training process. Preferably, the at least one statistical forecast dosage is determined by this and/or on the basis of this processing (preferably in a computer-implemented process step, in particular by the evaluation device).

Preferably, at least one variable relevant to the dosage, and preferably a plurality of variables relevant to the dosage, is determined by processing measured values using the simulation dosage model. This relevant variable can, for example, be a (preferably also time-dependent) pump performance of the pump device.

Preferably, the at least one quantity characteristic of the dosage and preferably the plurality of quantities characteristic of the dosage is determined from the measured values or data derived therefrom using a processor device and/or data processing device (using the simulation dosage model), by applying at least one (computer-implemented) pattern recognition method and/or feature extraction method and/or feature reduction method. Pattern recognition is understood here in particular to mean recognition of a time-dependent progression of measured values or their development and/or change over time.

Preferably, the determination of the at least one dosage quantity and/or preferably the processing of the (retrieved and in particular predetermined) plurality of measured values or data derived therefrom (using the simulation dosage model machine learning) is based on an (artificial) neural network and in particular on (computer-implemented) machine learning methods based on at least one, and in particular exactly one, (artificial) neural network. Preferably, the simulation-dosage model of machine learning is based on an (artificial) neural network.

Preferably, the neural network is designed as a deep neural network (DNN), in which the parameterisable processing chain has a plurality of processing layers, and/or a so called convolutional neural network (CNN) and/or a recurrent neural network (RNN).

Preferably, the data (to be processed), in particular the measured values (and/or data derived therefrom), are fed to the simulation dosage model or the (artificial) neural network as input variables. Preferably, the simulation dosage model or the artificial neural network maps the input variables to output variables as a function of a parameterisable processing chain, wherein the dosage variables (such as a pump output) are preferably selected as the output variable.

Preferably, the simulation dose model of machine learning or the artificial neural network is trained using predetermined training data, wherein the parameterisable processing chain is parameterised by the training. Preferably, measured values recorded by the measuring device or the measuring devices of the apparatus (or data derived therefrom) are used as training data. This offers the advantage that the simulation dosage model or the artificial neural network can be specially adapted to the conditions of the specific dosage device.

However, it is also conceivable that measured values recorded by a measuring device of (at least) another, preferably identical, apparatus (preferably from the same manufacturer) are used as training data. This offers the advantage that a large plurality of measured values can be provided and used.

However, it is also conceivable that (exclusively or partially) synthetically generated measured values or data generated via data augmentation are used as training data. This offers the advantage that rarely occurring classes of operating states can be simulated and the machine learning model can be trained using this.

The training process can be carried out locally (at the apparatus) and/or centrally and/or locally independently and/or on an external server in relation to the dosing device.

Preferably, a neural network trained in this way is used (in the framework and/or as a simulation dose model). Preferably, the training is carried out by means of supervised learning.

However, it would also be possible to train the simulation-dosage model or the artificial neural network by means of unsupervised learning, reinforcement learning or stochastic learning.

Preferably, the simulation dosage model is stored on a storage device (in particular described in more detail above), preferably external to the apparatus. Preferably, the apparatus can access this external storage device and, in particular, process the (predetermined) plurality of measured values by accessing it.

Preferably, the non-volatile storage device is an external storage device, in particular a cloud-based storage device and/or an external server (including storage device), wherein the storage device is accessed in particular via the Internet (and/or via a public and/or private network, in particular at least in sections wired and/or wireless). An external server is to be understood in particular as a server external to the apparatus, in particular a backend server.

The external server is, for example, a backend, in particular of a dosage device manufacturer or a service provider, which is set up to manage measured values (in particular of a plurality of measuring devices and/or a plurality of (in particular apparatus according to the invention). The functions of the backend or the external server can be carried out on (external) server farms. The (external) server can be a distributed system.

These external storage devices are preferably able to make the stored data and/or their analyses available to the machine from the external storage device. By analysing measured values as described here, it is possible to make predictions for the operation of the apparatus. For example, a forecast can be derived from a certain course of certain measured values that a certain component of the apparatus will soon fail. In this way, the user can be proactively instructed to carry out a certain maintenance or to replace a certain component.

It can also be concluded from certain measured values, such as pressure values, that the pump device is insufficiently vented. In this way, the evaluation device can simulate the experience of a machine operator, who can draw conclusions about other sources of error from the specific behaviour of certain measured values based on this experience.

An evaluation device and, in particular, an AI could derive predictions from large amounts of data. For example, when a certain fault occurs, other measured values could also be taken into account or it could be checked whether they had already changed before the fault occurred. In this way, the AI can use its “experience” to provide indications of a future error in the event of certain changes in the measured values. In this case, the AI emulates the experience of the machine operator.

As mentioned above, the machine data of many similar machines could also be stored and analysed. In this way, the evaluation device or the AI can learn whether and how the installation locations of the machines and their ambient conditions affect machine operation. Furthermore, the evaluation could also take into account different beverages.

As mentioned above, a virtual machine is preferably created (the simulation), which simulates the process of the actual machine and can work with the real data obtained. In this case, AI can contribute to the continuous improvement of the system.

Further advantages and embodiments are shown in the attached drawings. In the drawings:

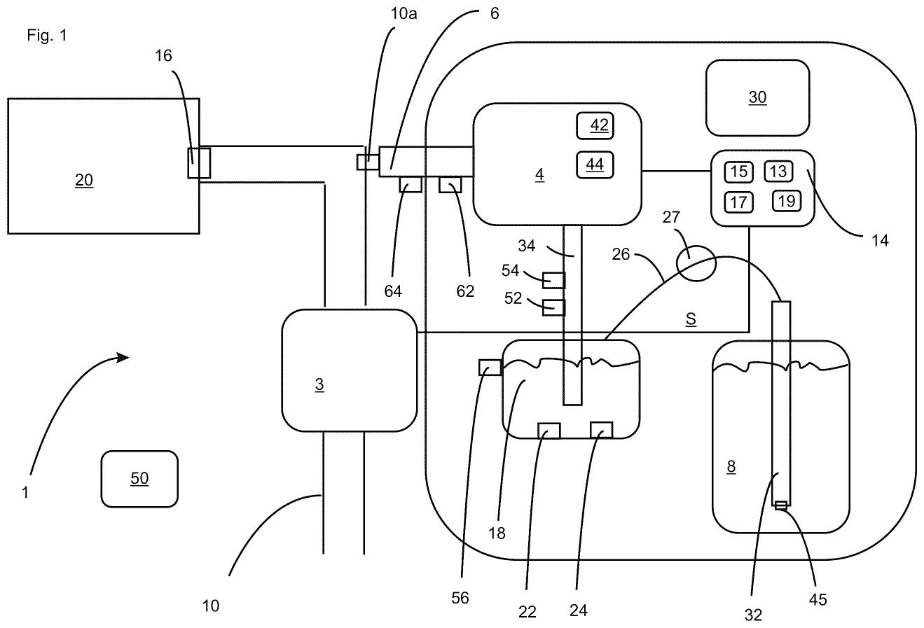

FIG. 1 shows a schematic representation of an apparatus according to the invention;

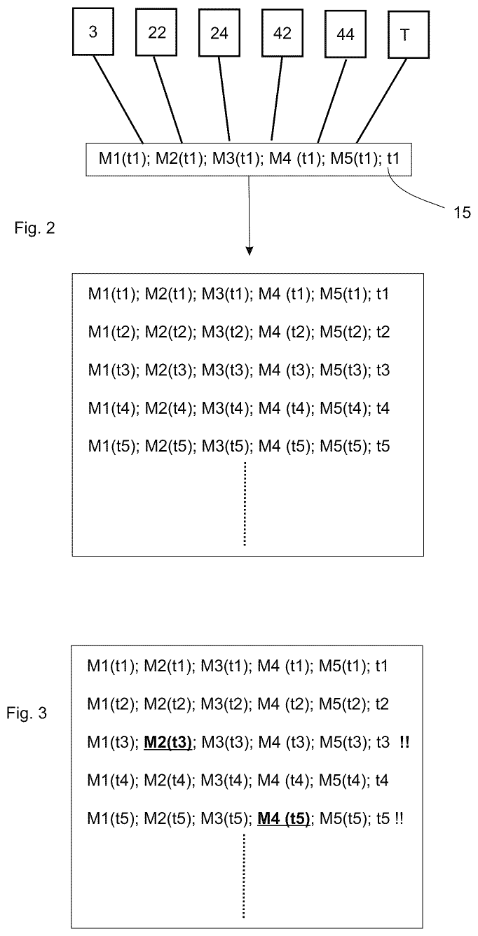

FIG. 2 shows a diagram illustrating the data storage;

FIG. 3 shows a representation of collected data.

FIG. 1 shows a schematic representation of an apparatus 1 according to the invention. It should be noted that the embodiment shown here is exemplary, in particular with regard to the sensors or measuring device shown, and that other sensors or locations for the sensors may be provided depending on the embodiment.

In FIG. 1, the reference sign 10 indicates a liquid line and, in particular, a beverage line in which the liquid or beverage is conveyed to a container 20.

The reference sign 3 indicates a measuring device, such as in particular but not exclusively a flow sensor, which is suitable and intended for determining the flow rate of the beverage flowing through the liquid line 10.

The reference symbol 4 indicates a pump device which is used to feed a preservative to the beverage via a feed line and, in particular, a pressure line 6 and a nozzle 10a. This pump device 4 is controlled by a control device 14. This nozzle 10a can preferably be tempered and, in particular, heated. Furthermore, a temperature measuring device (not shown) can be provided to determine the temperature of the nozzle.

The measuring device 3 transmits a value to the control device 14 that is characteristic of the flow rate of the liquid flowing through the liquid line 10 and the control device 14 controls the pump device 4 taking this value into account.

The reference symbol 8 indicates a first receiving container which is used to hold the liquid preservative. This receiving container is preferably interchangeable and is preferably designed without a sensor device. The reference sign 32 characterises a removal device which is suitable and intended for removing the liquid from the receiving container 8. This removal device is preferably designed as a hollow lance which sucks the preservative out of the receiving container.

The reference sign 45 identifies a sensor and in particular a pressure sensor, which in an advantageous embodiment is arranged at a lower end of the removal device.

Via a connecting line 26 (shown only schematically), preservative removed from the receiving container 8 is fed (preferably using a pump device 27) to a further receiving container 18, which is designed here as a buffer container.

The pump device 4 can suck the preservative out of the buffer container 18 via a connecting line 34. The buffer container 18 allows the apparatus 1 to be operated further during the periods in which the receiving container 8 is replaced.

In a preferred embodiment, at least one first pressure sensor 22 and preferably two pressure sensors 22, 24 are arranged on a bottom of the buffer container. By means of this pressure sensor 22, a pressure of the liquid inside the buffer container 18 can be determined and thus the filling level of the liquid in the buffer container can be inferred.

In an alternative embodiment or additionally, a pressure sensor or preferably two pressure sensors 52, 54 can also be provided on the connecting line. The measured values output by these pressure sensors 52, 54 can also (additionally or alternatively) be used to infer a flow rate of the liquid through the connecting line 34 and thus a delivery rate.

The reference sign 56 identifies a filling level sensor that determines a filling level of the preservative within the receiving container 18. The data measured by this filling level sensor is used in particular to check the values output by the pressure sensors.

The reference signs 62 and 64 indicate further pressure sensors which are arranged in the pressure line 6 in addition to or as an alternative to the sensors described above. In this way, too, a delivery rate of the preservative supplied to the beverage line 10 can be determined.

In addition, these pressure sensors can also be used to check whether the preservative is being supplied to the liquid line at a sufficient pressure or within specified limits.

The individual measured values from the sensors are preferably fed to the control device 14, which also controls and in particular regulates the pump device on the basis of these measured values.

Preferably, the pump device also has at least one sensor device 42 and preferably several sensor devices 42, 44. These may be position sensors, for example, which determine the position of specific pump elements. In addition, the sensors may also be current or voltage sensors which determine characteristic values for the operation of the pump device or the like.

The values from these sensor devices are also preferably fed to the control device 14 for controlling and/or regulating the pump device 4.

The reference sign 30 characterises a display and/or operating device for operating the apparatus. This display and/or operating device 30 is preferably suitable and intended for outputting information that is significant for the operation of the apparatus, such as measured pressures or the like. In addition, user inputs can preferably be made via this display and/or operating device 30.

A filling level display and/or pressure display and/or flow rate display can be visualised directly on a touch panel (the display and/or operating device 30). This makes it possible to notify the operator of bottle changes in good time.

The reference sign 15 indicates a storage device that is suitable and intended for storing measured values. This storage device can be integrated into the control device.

The reference symbol 17 indicates a timer device which specifies a time value with which different measured values are stored in the storage device 15.

The reference symbol 19 indicates an interface by means of which the stored data can be read out, for example by a USB stick.

The reference sign 13 indicates a transmission device by means of which stored data can be sent to a further storage device 50, such as a cloud storage.

FIG. 2 illustrates the procedure for storing data. Five measuring devices 3, 22, 24, 42 and 42 are shown here as examples, which output measured values that are characteristic of different properties of the apparatus. The reference symbol T indicates a timer. This can trigger the measured value acquisition and/or add a time value to the measured value acquisition.

An n-tuple, in this case a 6-tuple consisting of five measured values M1(t1), M2(t1), M3(t1), M4(t1) and M5(t1) measured at a specific time t1, is stored in the storage device. The time value t1 is also recorded.

Preferably, the measured values M1-M5 are assigned to the individual measuring devices mentioned above.

This storing is repeated-preferably cyclically. In this way, a plurality of tuples of values are recorded at different times. These values are stored in the storage device 15.

FIG. 3 shows a compilation of a plurality of measured values. Error states are also recorded, which are schematically labelled here by two exclamation marks. At the same time, the measuring device that supplied the faulty measured value is labelled, namely at time t3 the measuring device 22, which supplied the measured value M2 and at time T5 the measuring device 42, which supplied the measured value M4.

This data can be used to obtain information about the system, for example about the condition of the preservative or about technical components of the apparatus. If, for example, faulty readings from the measuring devices 42 and 44 occur more frequently, this could be an indication that components of the pump device 4, such as valves, are worn and need to be replaced in the near future.

If the measuring device 3 delivers strongly deviating measured values, this could indicate a fault in the higher-level beverage filling system.

The applicant reserves the right to claim all features disclosed in the application documents as being essential to the invention, provided that they are new, either individually or in combination, compared to the state of the art. It should also be noted that the individual figures also describe features which may be advantageous in themselves. The person skilled in the art immediately recognises that a certain feature described in a figure can also be advantageous without the adoption of further features from this figure. Furthermore, the person skilled in the art recognises that advantages can also result from a combination of several features shown in individual figures or in different figures.

1-15. (canceled)

16. An apparatus for preserving beverages, having a measuring device configured for determining a flow rate of a liquid flowing through a beverage line, and having a pump device configured to convey a preserving agent, in particular dialkyl dicarbonates, into the beverage line, and having at least one further measuring device configured to determine at least one further characteristic measured value, wherein the apparatus has a control device configured for controlling the pump device, the pump device can be controlled as a function of a flow rate determined by the measuring device and as a function of the further measured value, wherein
the apparatus has a storage device configured for storing at least the further characteristic measured value repeatedly.

17. The apparatus according to claim 16, wherein the apparatus has at least two further measuring devices, preferably at least three further measuring devices and particularly preferably at least four further measuring devices, which each measuring device is configured to determine at least one measured value characteristic of the operation of the apparatus.

18. The apparatus according to claim 16, wherein at least one measured value is selected from a group of measured values selected from values which are characteristic of a pressure of the preservative, of a temperature of the preservative, of an outside temperature, of a flow rate of the preservative, and of the presence of a gas.

19. The apparatus according to claim 16, wherein the apparatus has an interface which is configured to enable data communication with a further control device and/or a further storage device.

20. The apparatus according to claim 16, wherein the storage device is configured for storing a plurality of different values characteristic of the apparatus and/or its operation.

21. The apparatus according to claim 16, wherein the apparatus has an operating device configured to enable user input, wherein this operating device preferably has a display device configured for displaying data and/or measured values which are characteristic of the apparatus and/or the operation of the apparatus.

22. The apparatus according to claim 16, wherein the apparatus has a further communication interface configured to enable data to be transmitted to a storage device external to the apparatus.

23. The apparatus according to claim 16, wherein the storage device is configured for storing data characteristic of a fault condition of the installation.

24. The apparatus according to claim 16, wherein a processor device is provided which is configured to output at least one value characteristic of a forecast on the basis of previously recorded and/or stored values.

25. The apparatus according to claim 16, wherein the storage device is configured to allow repeated storage of data and/or measured values with time intervals selected from the group consisting of less than 200 ms, less than 100 ms, less than 50 ms, less than 20 ms, less than 10 ms, less than 5 ms and less than 2 ms.

26. A method for monitoring an apparatus for preserving beverages, wherein a measuring device determines a flow rate of a liquid flowing through a beverage line, and a pump device delivers a preservative, in particular dialkyl dicarbonates, into the beverage line, and at least one further measuring device determines a further characteristic measured value for the operation of the apparatus, wherein the apparatus has a control device for controlling the pump device and the pump device is controlled as a function of a flow rate determined by the measuring device and as a function of the further measured value, wherein the apparatus has a storage device which preferably stores the further characteristic measured value repeatedly and/or cyclically.

27. The method according to claim 26, wherein a plurality of measured values characteristic of the operation are recorded by means of a plurality of measuring devices and the storage device repeatedly stores these measured values.

28. The method according to claim 26, wherein the storage takes place at intervals selected from the group consisting of less than 100 s, less than 50 s, less than 20 s, less than 10 s, less than 5 s and less than 2 s.

29. The method according to claim 26, wherein a plurality of stored measured values are transmitted to a further storage device.

30. The method according to claim 26, wherein data characteristic of fault states of the apparatus are recorded and/or stored.

31. The apparatus according to claim 17, wherein at least one measured value is selected from a group of measured values selected from values which are characteristic of a pressure of the preservative, of a temperature of the preservative, of an outside temperature, of a flow rate of the preservative, and of the presence of a gas.

32. The apparatus according to claim 17, wherein the apparatus has an interface which is configured to enable data communication with a further control device and/or a further storage device.

33. The apparatus according to claim 17, wherein the storage device is configured for storing a plurality of different values characteristic of the apparatus and/or its operation.

34. The apparatus according to claim 17, wherein the apparatus has an operating device configured to enable user input, wherein this operating device preferably has a display device configured for displaying data and/or measured values which are characteristic of the apparatus and/or the operation of the apparatus.

35. The apparatus according to claim 17, wherein the storage device is configured to allow repeated storage of data and/or measured values with time intervals selected from the group consisting of less than 200 ms, less than 100 ms, less than 50 ms, less than 20 ms, less than 10 ms, less than 5 ms and less than 2 ms.
